(19) United States
(12) Patent Application Publication
(10) Pub. No.: US 2009/0161218 A1
(43) Pub. Date: Jun. 25, 2009

(54) COLOR DEVELOPING STRUCTURE AND METHOD FOR MANUFACTURING COLOR DEVELOPING STRUCTURE

(75) Inventors: Yasushi TAKANO, Matsumoto (JP); Toshimitsu HIRAI, Yamanashi (JP)

Correspondence Address: GLOBAL IP COUNSELORS, LLP, 1233 20TH STREET, NW, SUITE 700, WASHINGTON, DC, 20036-2680, US

(73) Assignee: Seiko Epson Corporation, Tokyo (JP)

(21) Appl. No.: 12/329,999

(22) Filed: Dec. 8, 2008

(30) Foreign Application Priority Data
Dec. 25, 2007 (JP) 2007-331532

(51) Int. Cl. G02B 5/28; B29D 11/00; B32B 17/00

(52) U.S. Cl. 359/586; 427/162

(57) ABSTRACT

A method for manufacturing a color developing structure, includes: defining a first region and a second region adjacent to the first region on a base body; forming, onto the first region, a first transparent thin film having a first refractive index by a liquid droplet ejection method with a first liquid material; forming, onto the first transparent thin film, a second transparent thin film having a second refractive index by a liquid droplet ejection method with a second liquid material; and stacking the first transparent thin films and the second transparent thin films in layers by alternately repeating the forming of the first transparent thin film and the forming of the second transparent thin film multiple times so that a first film body having the first color developing characteristics is formed onto the first region and the color developing structure is thereby obtained.

### CROSS-REFERENCE TO RELATED APPLICATION

This application is based on and claims priority from Japanese Patent Application No. 2007-331532, filed on Dec. 25, 2007, the contents of which are incorporated herein by reference.

### BACKGROUND

1. Technical Field

The present invention relates to a color developing structure and a method for manufacturing a color developing structure.

2. Related Art

As the design of decorative members (e.g., clock character sheet, bracelet, brooch, mobile phone case, etc.) and vehicle members (interior dashboard, etc.) has advanced, the feel of a material having a painted surface has been improved by using a mica flake or a processed mica as a brightness material, as well as known metallic painting using an aluminum flake brightness member.

The brightness member includes a pigment or a dye, and the brightness member influences color tone caused by the pigment or the dye. However, in the pigment or the dye, it is difficult to avoid fading in the present state.

A technique of a color developing structure focusing attention to a Morpho butterfly is described in Japanese Patent No. 3443656.

In this technique, a photocatalytic material thin film layer having a longitudinal rectangular shape and formed of TiO₂ or the like, and a supporting material thin film layer having a longitudinal rectangular shape thinner than the photocatalytic thin film layer and formed of SiO₂ are alternately laminated to form multilayer structures, and the multilayer structures are arranged to form a color developing member.

In the technique, after forming a multilayer thin film by sputtering or the like, a predetermined amount of a supporting material is removed by dry etching or wet etching to form an air space.

As described above, in the technique, since it is possible to widen a surface area coming into contact with a photocatalyst by the multilayer-film structure having the air space, a higher photocatalyst effect is expected.

Particularly, it is possible to realize clear color development such as metal luster, by a light interference effect caused by making the optical thicknesses of the photocatalyst layer and the air space ¼ of a color developing light wavelength, and a diffraction gird effect caused by the arranged structure.

However, in the above-described technique, there are the following problems.

In sputtering used to form the multilayer thin film layer or etching used to form the supporting material thin film layer, a large number of processes and large-scale equipment such as an exposure device are necessary. Accordingly, productivity is low.

In the color developing structure, when developing is performed with a specific pattern such as a character or a shape, a method of forming a color developing structure, for example, in the pattern, or a method of removing a part of the color developing structure in the pattern is conceivable. However, in any case, after forming a multilayer thin film and then forming a supporting material thin film layer by removing a predetermined amount of a supporting material by dry etching or wet etching, it is necessary to additionally perform patterning of the color developing structure by etching or the like. Accordingly, there is a problem in that a large amount of time is necessary.

In this technique, an etching agent for removing only the supporting material is used, but it is necessary to use an etching agent for removing both of the photocatalytic material thin film layer and the supporting material when performing patterning. Accordingly, the amount of new work may increase and the cost may increase.

### SUMMARY

An advantage of some aspects of the invention is to provide a color developing structure and a method for manufacturing a color developing structure, where it is possible to easily form a predetermined pattern.

A first aspect of the invention provides a method for manufacturing a color developing structure, including: defining a first region and a second region adjacent to the first region on a base body; forming, onto the first region, a first transparent thin film having a first refractive index by a liquid droplet ejection method with a first liquid material so that the first transparent thin film has a thickness determined based on first color developing characteristics; forming, onto the first transparent thin film, a second transparent thin film having a second refractive index by a liquid droplet ejection method with a second liquid material so that the second transparent thin film has a thickness determined based on the first color developing characteristics; and stacking the first transparent thin films and the second transparent thin films in layers by alternately repeating the forming of the first transparent thin film and the forming of the second transparent thin film multiple times so that a first film body having the first color developing characteristics is formed onto the first region and the color developing structure is thereby obtained.

In the method for manufacturing a color developing structure according to the first aspect of the invention, since the first film body having the first color developing characteristics is formed onto the first region, it is possible to produce a color with a predetermined pattern based on the shape of the first region and the shape of the second region, for example, by contrasting the first film body formed on the first region with the second region having color developing characteristics that is different from the first color developing characteristics, or by contrasting the first film body formed on the first region with a film body that is formed on the second region and has color developing characteristics that is different from the first color developing characteristics.

In the method for manufacturing a color developing structure according to the invention, it is possible to form a color developing structure by a simple method of forming a film using a first liquid material and a second liquid material with a thickness determined based on the first developing characteristics. Accordingly, large-scale equipment such as an exposure device is unnecessary, and thus it is possible to efficiently manufacture the color developing structure.

As characteristics of the color development, assuming that refractive indexes of a first liquid material (first transparent thin film) and a second liquid material (second transparent thin film) are n1 and n2, respectively, the thicknesses of the first transparent thin film and the second transparent thin film are t1 and t2, respectively, and refractive angles of the first transparent thin film and the second transparent thin film are θ1 and θ2; a reflective wavelength λ is represented by 2×(n1×t1×cos θ1+n2×t2×cos θ2) and a reflectance R (reflective intensity) is represented by (n1²−n2²)/(n1²+n2²).

When an optical thickness is n1×t1=n2×t2=λ/4, the color developing intensity is maximized.

Accordingly, in the invention, when the refractive indexes n1 and n2 and the refractive angles θ1 and θ2 are preset according to the used materials, it is possible to produce light having a desired wavelength with a high color developing intensity by appropriately setting the thicknesses t1 and t2 of the first transparent thin film and the second transparent thin film on the basis of the formula.

It is preferable that the method of the first aspect of the invention further include: forming, onto the second region, a second film body having second color developing characteristics that is different from the first color developing characteristics so that the color developing structure is obtained.

In the first aspect of the invention, contrast occurs by a difference between the first color developing characteristics of the first film body and the second color developing characteristics of the second film body. Accordingly, it is possible to produce a color in a predetermined pattern, by contrasting the color of the first film body with the color of the second film body.

It is preferable that, in the method of the first aspect of the invention, the forming of the second film body onto the second region, include: forming, onto the second region, a third transparent thin film having a third refractive index by a liquid droplet ejection method with a third liquid material so that the third transparent thin film has a thickness determined based on the second color developing characteristics; forming, onto the third transparent thin film, a fourth transparent thin film having a fourth refractive index by a liquid droplet ejection method with a fourth liquid material so that the fourth transparent thin film has a thickness determined based on the second color developing characteristics; and stacking the third transparent thin films and the fourth transparent thin films in layers by alternately repeating the forming of the third transparent thin film and the forming of the fourth transparent thin film multiple times.

In the first aspect of the invention, even in the second film body, it is possible to produce light having a desired wavelength with a high color developing intensity by appropriately setting the thicknesses of the third transparent thin film and the fourth transparent thin film on the basis of the formula, in a way similar to the case of setting the thicknesses of the first transparent thin film and the second transparent thin film on the basis of the formula.

It is preferable that, in the method of the first aspect of the invention, one of the first liquid material and the second liquid material be the same as the third liquid material, and the other of the first liquid material and the second liquid material be the same as the fourth liquid material.

In the first aspect of the invention, it is possible to form the second film body using the same material used for forming the first film body.

It is preferable that, in the method of the first aspect of the invention, the third refractive index be less than the fourth refractive index, and the third transparent thin film be formed so that the thickness of the third transparent thin film is greater than the thickness of the fourth transparent thin film.

In the first aspect of the invention, it is possible to produce light having a desired wavelength with a high color developing intensity by appropriately selecting the film thicknesses t3 and t4 satisfying the relationship of the formula n3×t3=n4×t4=λ/4 corresponding to the aforementioned formula.

It is preferable that, in the method of the first aspect of the invention, each of the forming of the third transparent thin film and the forming of the fourth transparent thin film include: applying a liquid material; and baking or drying the liquid material that has been applied.

In the first aspect of the invention, the third liquid material and the fourth liquid material are formed into films in the forming of the third transparent thin film and the forming of the fourth transparent thin film. Accordingly, it is possible to prevent the applied third liquid material and fourth liquid material from mixing to have a negative effect on the color developing characteristics.

It is preferable that, in the method of the first aspect of the invention, each of the forming of the first transparent thin film and the forming of the second transparent thin film include: applying a liquid material; and baking or drying the liquid material that has been applied.

In the first aspect of the invention, the first liquid material and the second liquid material are formed into films in the forming of the first transparent thin film and the forming of the second transparent thin film. Accordingly, it is possible to prevent the applied first liquid material and second liquid material from mixing to have a negative effect on the color developing characteristics.

It is preferable that, in the method of the first aspect of the invention, the first refractive index be less than the second refractive index, and the first transparent thin film be formed so that the thickness of the first transparent thin film is greater than the thickness of the second transparent thin film.

In the first aspect of the invention, it is possible to produce light having a desired wavelength with a high color developing intensity by appropriately selecting the film thicknesses t1 and t2 satisfying the relationship of the aforementioned formula n1×t1=n2×t2=λ/4.

It is preferable that, in the method of the first aspect of the invention, the first film body that is constituted by a plurality of the first transparent thin films and a plurality of the second transparent thin films include a lowermost layer, an uppermost layer, and a plurality of intermediate layers. In this method, the first transparent thin films and the second transparent thin films are formed so that the thicknesses of the transparent thin films that are positioned at the lowermost layer and the uppermost layer are greater than the thickness of the transparent thin film that is positioned at one of the intermediate layers.

This method of the first aspect of the invention is obtained based on the result of experiment and simulation. In the first aspect of the invention, it is possible to obtain satisfactory color developing characteristics.

In this case, it is particularly preferable that, in the method of the first aspect of the invention, the first transparent thin films and the second transparent thin films be formed so that the thicknesses of the transparent thin films that are positioned at the lowermost layer and the uppermost layer are twice the thickness of the transparent thin film that is positioned at one of the intermediate layers. In this case, it is possible to obtain satisfactory light emitting characteristics (reflective characteristics).

It is preferable that, in the method of the first aspect of the invention, the forming of the first transparent thin film and the second transparent thin film include at least one of the forming the first transparent thin film that has the thickness determined based on the particle diameter of a first formation material used for forming the first transparent thin film, and the forming the second transparent thin film that has the thickness determined based on the particle diameter of a second formation material used for forming the second transparent thin film.

In the first aspect of the invention, it is possible to precisely form at least one of the first transparent thin film and the second transparent thin film with a regular thickness having uniformity.

A second aspect of the invention provides a color developing structure including: a first transparent thin film that is formed with a first formation material, has a thickness determined based on first color developing characteristics, and has a first refractive index; a second transparent thin film that is formed on the first transparent thin film with a second formation material, has a thickness determined based on the first color developing characteristics, and has a second refractive index; and a first film body in which the first transparent thin films and the second transparent thin films are alternately stacked in layers.

In the color developing structure of the second aspect of the invention, since the first film body having the first color developing characteristics is formed, it is possible to produce a color with a predetermined pattern based on the shape of the first film body, for example, by contrasting the first film body with a portion having color developing characteristics that is different from the first color developing characteristics, or by contrasting the first film body with a film body having color developing characteristics that is different from the first color developing characteristics.

As characteristics of the color development, assuming that refractive indexes of a first liquid material (first transparent thin film) and a second liquid material (second transparent thin film) are n1 and n2, respectively, the thicknesses of the first transparent thin film and the second transparent thin film are t1 and t2, respectively, and refractive angles of the first transparent thin film and the second transparent thin film are θ1 and θ2; a reflective wavelength λ is represented by 2×(n1×t1×cos θ1+n2×t2×cos θ2) and a reflectance R (reflective intensity) is represented by (n1²−n2²)/(n1²+n2²).

When an optical thickness is n1×t1=n2×t2=λ/4, the color developing intensity is maximized.

Accordingly, in the invention, when the refractive indexes n1 and n2 and the refractive angles θ1 and θ2 are preset according to the used materials, it is possible to produce light having a desired wavelength with a high color developing intensity by appropriately setting the thicknesses t1 and t2 of the first transparent thin film and the second transparent thin film on the basis of the formula.

It is preferable that the color developing structure of the second aspect of the invention further include: a second film body, that is formed on a region different from the region on which the first film body is formed, has second color developing characteristics different from the first color developing characteristics.

In the second aspect of the invention, contrast occurs by a difference between the first color developing characteristics of the first film body and the second color developing characteristics of the second film body. Accordingly, it is possible to produce a color in a predetermined pattern, by contrasting the color of the first film body with the color of the second film body.

It is preferable that, in the color developing structure of the second aspect of the invention, the second film body include: a third transparent thin film that is formed with a third formation material, has a thickness determined based on the second color developing characteristics, and has a third refractive index; and a fourth transparent thin film that is formed with a fourth formation material, has a thickness determined based on the second color developing characteristics, and has a fourth refractive index. In the color developing structure, the second film body is formed by alternately stacking the third transparent thin films and the fourth transparent thin films in layers.

In the second aspect of the invention, even in the second film body, it is possible to produce light having a desired wavelength with a high color developing intensity by appropriately setting the thicknesses of the third transparent thin film and the fourth transparent thin film on the basis of the formula, in a similar manner in that the first formation material (first transparent thin film) and the second formation material (second transparent thin film) are used.

It is preferable that, in the color developing structure of the second aspect of the invention, one of the first formation material and the second formation material be the same as the third formation material, and the other of the first formation material and the second formation material be the same as the fourth formation material.

In the second aspect of the invention, it is possible to form the second film body using the same material used for forming the first film body.

It is preferable that, in the color developing structure of the second aspect of the invention, the third refractive index be less than the fourth refractive index, and the third transparent thin film be formed so that the thickness of the third transparent thin film is greater than the thickness of the fourth transparent thin film.

In the second aspect of the invention, it is possible to produce light having a desired wavelength with a high color developing intensity by appropriately selecting the film thicknesses t3 and t4 satisfying the relationship of the formula n3×t3=n4×t4=λ/4 corresponding to the aforementioned formula.

It is preferable that, in the color developing structure of the second aspect of the invention, the first refractive index be less than the second refractive index, and the first transparent thin film be formed so that the thickness of the first transparent thin film is greater than the thickness of the second transparent thin film.

In the second aspect of the invention, it is possible to produce light having a desired wavelength with a high color developing intensity by appropriately selecting the film thicknesses t1 and t2 satisfying the relationship of the aforementioned formula n1×t1=n2×t2=λ/4.

It is preferable that, in the color developing structure of the second aspect of the invention, the first film body that is constituted by a plurality of the first transparent thin films and a plurality of the second transparent thin films include a lowermost layer, an uppermost layer, and a plurality of intermediate layers. In this color developing structure, the first transparent thin films and the second transparent thin films are formed so that the thicknesses of the transparent thin films that are positioned at the lowermost layer and the uppermost layer are greater than the thickness of the transparent thin film that is positioned at one of the intermediate layers.

This color developing structure of the second aspect of the invention is obtained based on the result of experiment and simulation. In the second aspect of the invention, it is possible to obtain satisfactory color developing characteristics.

In this case, it is particularly preferable that, in the color developing structure of the second aspect of the invention, the first transparent thin films and the second transparent thin films be formed so that the thicknesses of the transparent thin films that are positioned at the lowermost layer and the uppermost layer are twice the thickness of the transparent thin film that is positioned at one of the intermediate layers. In this case, it is possible to obtain satisfactory light emitting characteristics (reflective characteristics).

It is preferable that, in the color developing structure of the second aspect of the invention, the thickness of the first transparent thin film be defined based on the particle diameter of the first formation material.

In the second aspect of the invention, it is possible to precisely form the first transparent thin film with a regular thickness having uniformity.

It is preferable that, in the color developing structure of the second aspect of the invention, the thickness of the second transparent thin film be defined based on the particle diameter of the second formation material.

In the second aspect of the invention, it is possible to precisely form the second transparent thin film with a regular thickness having uniformity.

### BRIEF DESCRIPTION OF THE DRAWINGS

FIG. 1 is a perspective view showing a liquid drop ejection apparatus.

FIG. 2 is a cross-sectional view showing a liquid drop ejection head.

FIG. 3 is a cross-sectional view showing a color developing structure C having a multilayer structure formed on a substrate P.

FIGS. 4A to 4C are diagrams illustrating the relationship between a light emitting wavelength and a reflectance according to a first embodiment.

FIG. 5 is a plan view showing a color developing structure C according to the first embodiment.

FIG. 6 is a cross-sectional view showing the color developing structure C according to the first embodiment.

FIG. 7 is a plan view showing a color developing structure C according to the second embodiment.

FIG. 8 is a cross-sectional view showing the color developing structure C according to the second embodiment.

FIG. 9 is a plan view showing a color developing structure C according to the third embodiment.

FIG. 10 is a cross-sectional view showing the color developing structure C according to the third embodiment.

FIG. 11 is a cross-sectional view showing the color developing structure C according to the third embodiment.

FIG. 12 is a cross-sectional view showing a color developing structure C according to the fourth embodiment.

FIG. 13 is a cross-sectional view showing a color developing structure C according to the fifth embodiment.

FIG. 14A is a diagram illustrating the refractive index and the thickness of each of eleven layers of a color developing structure C according to a sixth embodiment, and FIG. 14B is a diagram illustrating the relationship between wavelength and reflectance in the film structure shown in FIG. 14A.

FIG. 15A is a diagram illustrating the refractive index and the thickness of each of eleven layers of the color developing structure C according to the sixth embodiment, and FIG. 15B is a diagram illustrating the relationship between wavelength and reflectance in the film structure shown in FIG. 15A.

FIG. 16A is a diagram illustrating the refractive index and the thickness of each of eleven layers of the color developing structure C according to the sixth embodiment, and FIG. 16B is a diagram illustrating the relationship between wavelength and reflectance in the film structure shown in FIG. 16A.

FIG. 17A is a diagram illustrating the refractive index and the thickness of each of eleven layers of the color developing structure C according to the sixth embodiment, and FIG. 17B is a diagram illustrating the relationship between wavelength and reflectance in the film structure shown in FIG. 17A.

FIG. 18A is a diagram illustrating the refractive index and the thickness of each of eleven layers of the color developing structure C according to the sixth embodiment, and FIG. 18B is a diagram illustrating the relationship between wavelength and reflectance in the film structure shown in FIG. 18A.

FIG. 19A is a diagram illustrating the refractive index and the thickness of each of eleven layers of the color developing structure C according to the sixth embodiment, and FIG. 19B is a diagram illustrating the relationship between wavelength and reflectance in the film structure shown in FIG. 19A.

FIG. 20A is a diagram illustrating the refractive index and the thickness of each of eleven layers of the color developing structure C according to the sixth embodiment, and FIG. 20B is a diagram illustrating the relationship between wavelength and reflectance in the film structure shown in FIG. 20A.

FIG. 21A is a diagram illustrating the refractive index and the thickness of each of eleven layers of the color developing structure C according to the sixth embodiment, and FIG. 21B is a diagram illustrating the relationship between wavelength and reflectance in the film structure shown in FIG. 21A.

FIG. 22A is a diagram illustrating the refractive index and the thickness of each of eleven layers of a color developing structure C according to a seventh embodiment, and FIG. 22B is a diagram illustrating the relationship between wavelength and reflectance in the film structure shown in FIG. 22A.

### DESCRIPTION OF EXEMPLARY EMBODIMENTS

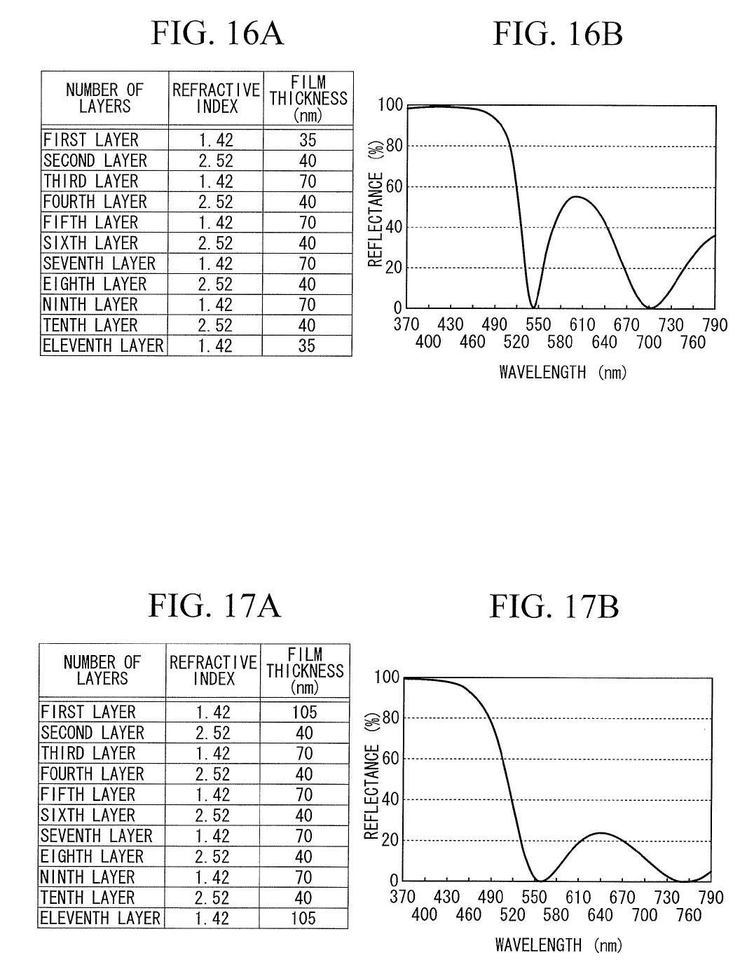

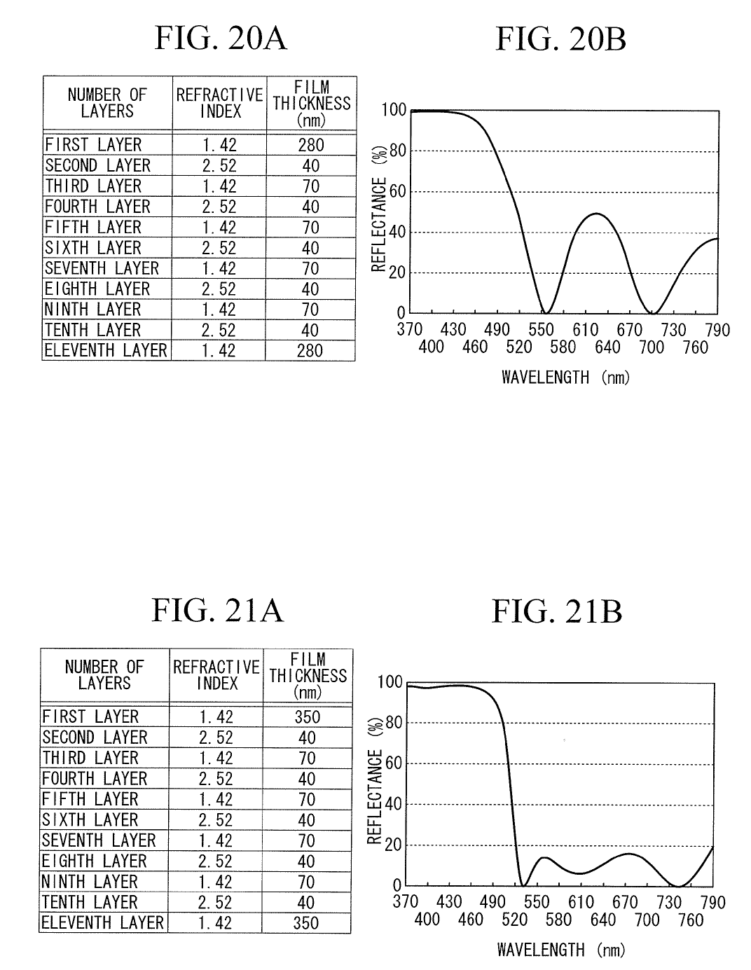

Hereinafter, embodiments of a color developing structure and a method for manufacturing a color developing structure will be described with reference to FIGS. 1 to 22B.

Liquid Drop Ejection Apparatus

Firstly, a liquid drop ejection apparatus for use in the manufacture of a method for manufacturing a color developing structure will be described.

FIG. 1 shows a liquid drop ejection apparatus.

A liquid drop ejection apparatus IJ (ink jet apparatus) ejects (drops) liquid drops from a liquid drop ejection head to a substrate P.

The liquid drop ejection apparatus IJ includes a liquid drop ejection head 301, an X direction drive axis 304, a Y direction guide axis 305, a controller CONT, a stage 307, a cleaning mechanism 308, a base 309, and a heater 315.

The stage 307 supports the substrate P to be provided with an ink (liquid material, liquid substance) by the liquid drop ejection apparatus IJ. The stage 307 includes a fixation mechanism (not shown) that fixes the substrate P in a reference position.

The liquid drop ejection head 301 is a multi-nozzle type liquid drop ejection head provided with a plurality of ejection nozzles. The longitudinal direction and X axis direction of the liquid drop ejection head 301 coincide.

The plurality of ejection nozzles are formed in the bottom surface of the liquid drop ejection head 301 in rows, in the X axis direction, spaced apart at a fixed distance.

An ink including fine conductive particles is ejected from the ejection nozzles of the liquid drop ejection head 301 to the substrate P supported on the stage 307.

An X direction drive motor 302 is connected to the X direction drive axis 304.

The X direction drive motor 302 is, for example, a stepping motor. When supplied with a drive signal for the X direction by the controller CONT, the X direction drive motor 302 causes the X direction drive axis 304 to rotate.

When the X direction drive axis 304 is rotated, the liquid drop ejection head 301 moves in the X axis direction.

The Y direction guide axis 305 is fixed so as not to move with respect to the base 309.

The stage 307 is provided with a Y direction drive motor 303.

The Y direction drive motor 303 is, for example, a stepping motor. When supplied with a drive signal for the Y direction by the controller CONT, the stage 307 moves in the Y direction.

The controller CONT supplies a voltage for controlling liquid drop ejection to the liquid drop ejection head 301.

Furthermore, the controller CONT supplies a drive pulse signal for controlling the movement in the X direction of the liquid drop ejection head 301 to the X direction drive motor 302, and supplies a drive pulse signal for controlling the movement in the Y direction of the stage 307 to the Y direction drive motor 303.

The cleaning mechanism 308 cleans the liquid drop ejection head 301.

The cleaning mechanism 308 is provided with a drive motor for the Y direction (not shown).

The cleaning mechanism 308 moves along the Y direction guide axis 305 by means of the drive motor in a manner in that the drive motor is driven in the Y direction.

The movement of the cleaning mechanism 308 is also controlled by the controller CONT.

The heater 315 herein is used for heating the substrate P by lamp annealing. The heater 315 evaporates and dries the solvent included in the liquid material applied on the substrate P.

Turning on and off of the heater 315 is also controlled by the controller CONT.

The liquid drop ejection apparatus IJ ejects liquid drops to the substrate P while relatively scanning the liquid drop ejection head 301 and the stage 307 for supporting the substrate P.

Here, in the description below, the Y direction is referred to as a scanning direction, and the X direction that is perpendicular to the Y direction is referred to as a non-scanning direction.

Therefore, the ejection nozzles of the liquid drop ejection head 301 are provided in lines, spaced apart at a fixed distance, in the X direction, that is, the non-scanning direction.

In FIG. 1, the liquid drop ejection head 301 is disposed perpendicularly to the traveling direction of the substrate P. However, the liquid drop ejection head 301 may be arranged to be intersected with the traveling direction of the substrate P by adjusting the angle of the liquid drop ejection head 301.

As a result, adjustment of the angle of the liquid drop ejection head 301 allows adjustment of pitches between the nozzles.

Therefore, the liquid drop ejection apparatus IJ may be configured so that the distance between the substrate P and the nozzle face is adjustable to any value.

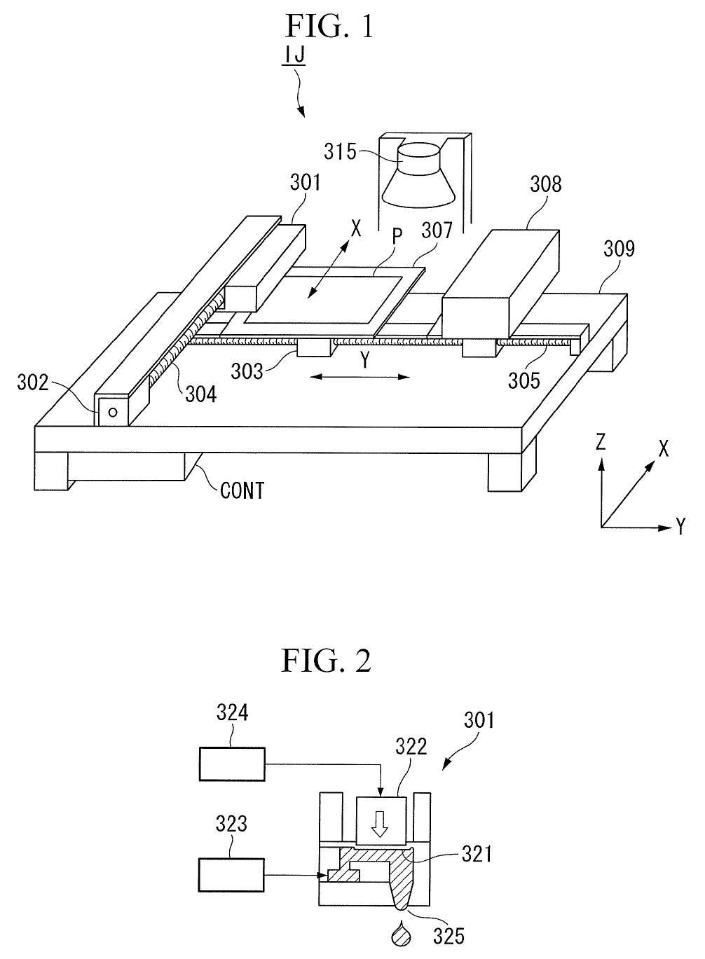

FIG. 2 is a cross-sectional view of the liquid drop ejection head 301.

In the liquid drop ejection head 301, a piezo element 322 is disposed adjacent to a liquid chamber 321 that stores a liquid material (ink for wiring, etc.).

The liquid material is supplied to the liquid chamber 321 via a liquid supply system 323 including a material tank that stores the liquid material.

The piezo element 322 is connected to a drive circuit 324. A voltage is applied to the piezo element 322 via the drive circuit 324 to deform the piezo element 322. This, in turn, deforms the liquid chamber 321 to eject the liquid material from a nozzle 325.

In this case, the amount of deformation of the piezo element 322 is controlled by changing the value of the applied voltage.

Furthermore, the speed of deformation of the piezo element 322 is controlled by changing the frequency of the applied voltage.

Liquid ejection by the piezo system has an advantage in that it is difficult to affect the composition of a material, since heat is not applied to the material.

An electromechanical transformation system described above is not limited to the method of ejecting a liquid drop. As ejection techniques for a method of ejecting a liquid drop, a charging control system, a pressurized vibration system, an electro-thermal transformation system, an electrostatic attraction system, or the like can be adopted.

The charging control system is one in which an electric charge electrode imparts electric charge to a material and a deflection electrode ejects the material in the desired ejecting direction from the nozzle to the substrate.

The pressurized vibration system is one in which, for example, about 30 kg/cm² of super high pressure is applied to a material and the material is ejected on the tip of a nozzle. In this system, when a control voltage is not applied, the material is ejected from the nozzle in the straight direction. When the control voltage is applied, electrostatic repulsion is induced in the material and the material is scattered so as to be prevented from being ejected from the nozzle.

The electro-thermal transformation system is one in which a material is abruptly vaporized by a heater provided in a space where the material is stored to generate bubbles, and the material in the space is ejected by the pressure of the bubbles.

The electrostatic attraction system is a system in which a very small pressure is applied to the inside of a space where a material is stored, to form a meniscus of the material in a nozzle and, in this condition, electrostatic attraction is applied to draw out the material.

Other than these, techniques such as a system that utilizes change in viscosity of fluid by an electric field and a system in which a material is ejected by a discharge spark are also applicable.

The method of ejecting a liquid drop has advantages in that little is wasted in the use of material and that a desired amount of the material is exactly disposed in a desired position.

An amount of a drop of a liquid material (fluid substance) ejected by the method of ejecting a liquid drop is, for example, 1 to 300 nano grams.

### First Embodiment

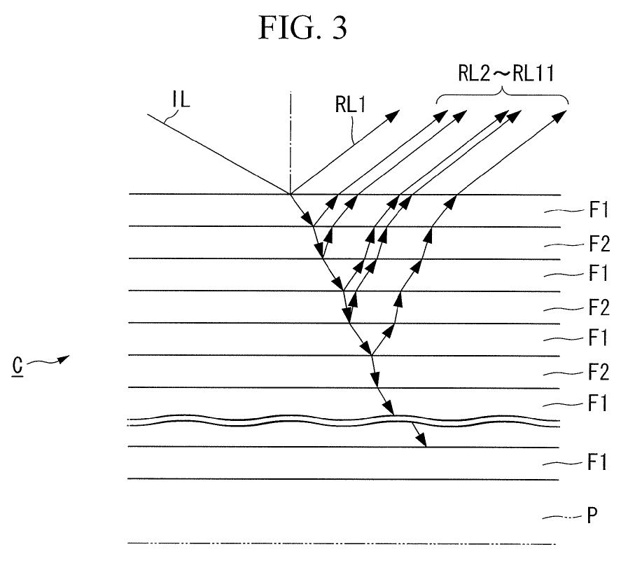

Next, using the above-described liquid drop ejection apparatus, a first embodiment of a method for manufacturing a color developing structure on a substrate P will be described with reference to FIG. 3.

Firstly, the configuration of a color developing structure will be described.

FIG. 3 is a cross-sectional view showing a color developing structure C having a multilayer structure formed on a substrate P.

The color developing structure C (first film body) shown in FIG. 3 is formed by alternately forming a plurality of first transparent thin films F1 and a plurality of second transparent thin films F2 having different refractive indexes.

In the embodiment, in order from the substrate P, the first transparent thin films F1 are formed in odd-numbered layers such as a first layer, a third layer, . . . , to an eleventh layer. Also, the second transparent thin films F2 are formed in even-numbered layers such as a second layer, . . . , to a tenth layer. Therefore, a color developing structure C is formed by the eleven-layer thin films.

As the substrate P (base body), a glass substrate, a Si substrate, a plastic substrate, a metal substrate, or the like may be appropriately selected.

As a material for forming the first transparent thin film F1 and the second transparent thin film F2, polysiloxane resin (refractive index 1.42), SiO₂ (quartz; 1.45), Al₂O₃ (alumina; refractive index 1.76), ZnO (zinc oxide; refractive index 1.95), titanium oxide (refractive index 2.52), Fe₂O₃ (iron oxide; refractive index 3.01), or the like may be appropriately selected.

To form the color developing structure C on the substrate P, firstly, liquid droplets of a first liquid material including a material (first formation material) for forming the first transparent thin film using the liquid drop ejection apparatus IJ are applied onto the substrate P with a predetermined thickness, and then it is dried, for example, at 180° C. for 1 minute and baked (cured) at 200° C. for 3 minutes. As a result, the first transparent thin film F1 is formed on a formation region of the substrate P. That is, the first transparent thin film F1 is formed as the first layer of a film body constituting the color developing structure C (first process).

Next, liquid droplets of a second liquid material including a material (second formation material) for forming the second transparent thin film using the liquid drop ejection apparatus IJ are applied onto the first transparent thin film F1 with a predetermined thickness, and then it is dried and baked under the same conditions. As a result, the second transparent thin film F2 is formed as the second layer of a film body constituting the color developing structure C (second process). In other words, this second transparent thin film F2 that is formed on the first transparent thin film F1 is formed as a first layer of the second transparent thin film F2 in a plurality of layers of the film body constituting the color developing structure C.

The first process and the second process as described above are alternately repeated, that is the first process is performed six times and the second process is performed five times, thereby forming a color developing structure C in which the first transparent thin film F1 and the second transparent thin film F2 are formed with a predetermined thickness.

In the embodiment, the color developing structure C is formed using the thin film materials, in which the refractive index (first refractive index) of the first transparent thin film F1 is less than the refractive index (second refractive index) of the second transparent thin film F2, and the thickness of the first transparent thin film F1 is greater than the thickness of the second transparent thin film F2.

As color developing characteristics (first color developing characteristics) of the color developing structure C having the multilayer structure, reflected light RL1 reflected by the uppermost layer transparent thin film with respect to incident light IL interferes with reflected light RL2 to RL11 that refracts and enters the transparent thin film and is reflected by the next layer transparent thin film and the layer transparent thin films below it and passes out.

On the basis of a thin film interference theory, in an interference color (reflective wavelength) and in an intensity, when refractive indexes of the first transparent thin film F1 and the second transparent thin film F2 are n1 and n2, respectively, thicknesses of the first transparent thin film F1 and the second transparent thin film F2 are t1 and t2, respectively, and refractive angles of the first transparent thin film FI and the second transparent thin film F2 are θ1 and θ2; a reflective wavelength λ is represented by the following formula.

λ=2×(n1×t1×cos θ1+n2×t2×cos θ2) (1)

A reflectance (reflective intensity) R is represented by the following formula.

R=(n1²−n2²)/(n1²+n2²) (2)

As clearly seen from the formula (1) representing the reflectance, the difference between the refractive indexes of the first transparent thin film F1 and the second transparent thin film F2 is large. Accordingly, the reflective intensity (color developing intensity) increases as much as the difference.

When the following formula is satisfied, the color developing intensity becomes maximized.

n1×t1=n2×t2=λ/4 (3)

When the materials of the first transparent thin film F1 and the second transparent thin film F2 are selected, for example, on the basis of the reflective intensity; the refractive indexes n1 and n2 and the refractive angles θ1 and θ2 are determined. Accordingly, using the formulas (1) to (3), it is possible to set the number of layers to obtain desired color developing characteristics (λ), the thickness t1 of the first transparent thin films F1 and thickness t2 of the second transparent thin films F2, and a desired reflectance.

### EXAMPLE

A first transparent thin film F1 and a second transparent thin film F2 were formed using a first liquid material including a siloxane polymer (refractive index 1.42) as the first transparent thin film F1 and using a second liquid material including a titanium oxide (refractive index 2.52) as the second transparent thin film F2.

For example, to produce a blue color (λ=480 nm), the first transparent thin film F1 was formed with a thickness t1 of 84.5 nm and the second transparent thin film F2 was formed with a thickness t2 of 47.6 nm, on the basis of the formula (3).

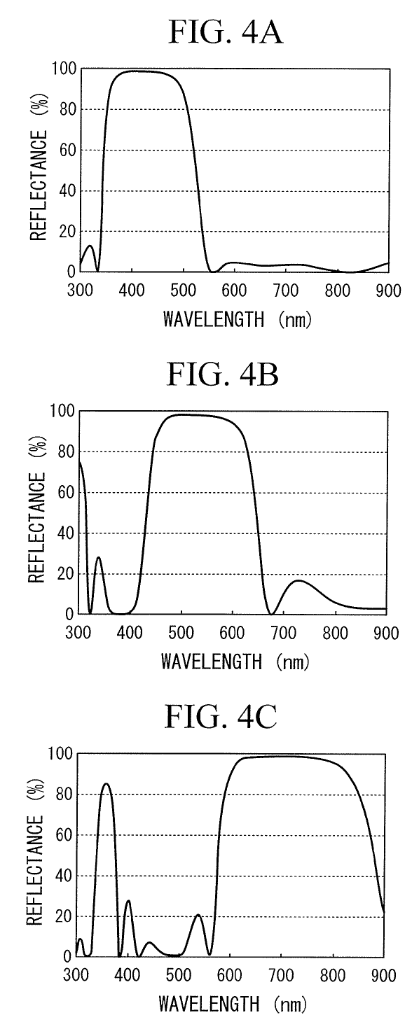

As a result, as shown in FIG. 4A, it is possible to obtain blue color developing characteristics at a reflectance that is greater than or equal to 80%.

Similarly, for example, to produce a green color (λ=520 nm), the first transparent thin film F1 was formed with a thickness t1 of 91.5 nm and the second transparent thin film F2 was formed with a thickness t2 of 52.0 nm, on the basis of the formula (3).

As a result, as shown in FIG. 4B, it is possible to obtain green color developing characteristics at a reflectance that is greater than or equal to 80%.

Similarly, for example, to produce a red color (λ=630 nm), the first transparent thin film F1 was formed with a thickness t1 of 111.0 nm and the second transparent thin film F2 was formed with a thickness t2 of 62.5 nm, on the basis of the formula (3).

As a result, as shown in FIG. 4C, it is possible to obtain red color developing characteristics at a reflectance that is greater than or equal to 80%.

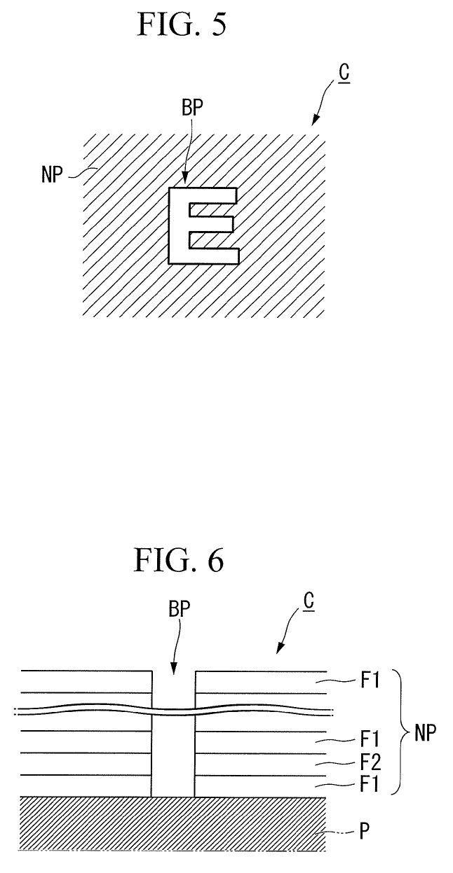

Next, a procedure for forming a predetermined pattern using the above-described method for manufacturing the color developing structure will be described with reference to FIGS. 5 and 6.

FIG. 5 is a plan view showing the color developing structure C, and FIG. 6 is a cross-sectional view showing the color developing structure C.

The color developing structure C shown in FIGS. 5 and 6 forms a pattern of a character “E”. The color developing structure C includes a first pattern portion NP on which a film body (first film body) is formed and a second pattern portion BP on which a film body is not formed. The first pattern portion NP is formed around the second pattern portion BP, that is the second pattern portion BP (second region) is adjacent to the first pattern portion NP (first region). This pattern of a character “E” is formed by contrasting the first pattern portion NP with the second pattern portion BP.

In the method for manufacturing the color developing structure C as shown in FIGS. 5 and 6, before forming the first pattern portion NP and the second pattern portion BP by the liquid drop ejection apparatus IJ, a first region on which the first pattern portion NP is formed (i.e., a region on which a first film body is formed) and a second region on which the second pattern portion BP is formed (i.e., a region on which a first film body is not formed) are defined on the substrate P. Specifically, in order to form the color developing structure C onto the substrate P, bitmap data that is positional data corresponding to the first region and the second region is formed, the first region and the second region are thereby defined. The bitmap data in which the first region and the second region are defined is stored in the controller CONT of the above-described liquid drop ejection apparatus IJ (process for defining a first region and a second region). In the liquid drop ejection apparatus IJ, the liquid drop ejection head 301 ejects formation materials for forming the first transparent thin film F1 and the second transparent thin film F2 based on the bitmap data that was stored in the controller CONT. After the liquid drop ejection head 301 ejected the formation materials, the film body (first film body) that is the color developing structure C is formed by performing the above-described drying process and the baking process, and the first pattern portion NP is thereby formed. In addition, in the liquid drop ejection apparatus IJ, a liquid material is not ejected onto the second region, and a film body is not thereby formed on the second region.

As shown in FIG. 6, the first pattern portion NP has a configuration in which the first transparent thin film F1 formed with a thickness of 150 nm using a first liquid material including a siloxane polymer (refractive index 1.42) as a material for forming the first transparent thin film, and the second transparent thin film F2 formed with a thickness of 35 nm using a second liquid material including a titanium oxide (refractive index 2.52) as a material for forming the second transparent thin film are alternately laminated (stacked) into multi layers (e.g., the first transparent thin film F1: six layers, the second transparent thin film F2: five layers) on the substrate P.

In the embodiment, for the second pattern portion BP, a film such as the transparent thin film is not formed.

When a transparent thin film is laminated on the previously formed transparent thin film (e.g., F1), it is preferable to apply a material having a liquid repellency onto the second pattern portion BP and form a film having a liquid repellency before applying a liquid material.

Accordingly, the applied liquid material is repelled by the film having a liquid repellency, flows into the first pattern portion NP, and thus it is possible to prevent a negative effect on the color developing characteristics in the second pattern portion BP.

In the color developing structure C having the aforementioned configuration, for the first pattern portion NP, as described above, a color is developed according to the thicknesses of the first transparent thin film F1 and the second transparent thin film F2. For the second pattern portion BP, color development is not substantially performed. Accordingly, it is possible to easily and clearly form a character “E” formed in the second pattern portion BP by contrasting the difference in the color developing characteristics of the first pattern portion NP and the second pattern portion BP.

In the embodiment, the first transparent thin film F1 and the second transparent thin film F2 are alternately stacked in layers by using a liquid droplet ejection method so that each of the thicknesses of the first transparent thin film F1 and the second transparent thin film F2 is defined based on the desired color developing characteristics. Therefore, it is possible to easily and efficiently manufacture the color developing structure C having the desired color developing characteristics without increasing the number of processes or without needing large-scale equipment.

In the embodiment, the transparent thin film layers are applied and dried (baked), and then the next transparent thin film layer is formed. Accordingly, it is possible to prevent a negative effect on the color developing characteristics caused by mixing the applied first liquid material and second liquid material, and it is possible to precisely manage the thicknesses of the layers.

### Second Embodiment

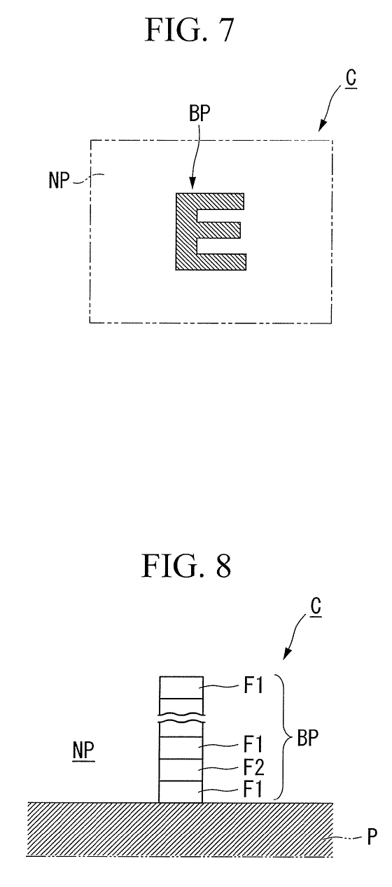

A second embodiment of a color developing structure C formed on a substrate P will be described with reference to FIGS. 7 and 8.

In FIGS. 7 and 8, the same reference signs are given to the same elements as the constituent elements of the first embodiment shown in FIGS. 5 and 6, and the descriptions thereof are omitted.

In the first embodiment, the transparent thin film is not formed in the second pattern portion BP, and the transparent thin film is formed only in the first pattern portion NP. However, in the second embodiment, a transparent thin film is formed in the second pattern portion BP, and a transparent thin film is not formed in the first pattern portion NP.

That is, as shown in FIGS. 7 and 8, in a color developing structure C according to the second embodiment, a thin film is not formed in the first pattern portion NP, and a first transparent thin film F1 and a second transparent thin film F2 are alternately laminated with a shape of a character “E” in the second pattern portion BP.

Materials and thicknesses of the first transparent thin film F1 and the second transparent thin film F2 are the same as the first embodiment.

In the color developing structure C having the aforementioned configuration, for the second pattern portion BP, as described above, a color is developed according to the thicknesses of the first transparent thin film F1 and the second transparent thin film F2. For the first pattern portion NP, color development is not substantially performed. Accordingly, it is possible to easily and clearly form a character “E” formed in the second pattern portion BP by contrasting the first pattern portion NP with the second pattern portion BP.

### Third Embodiment

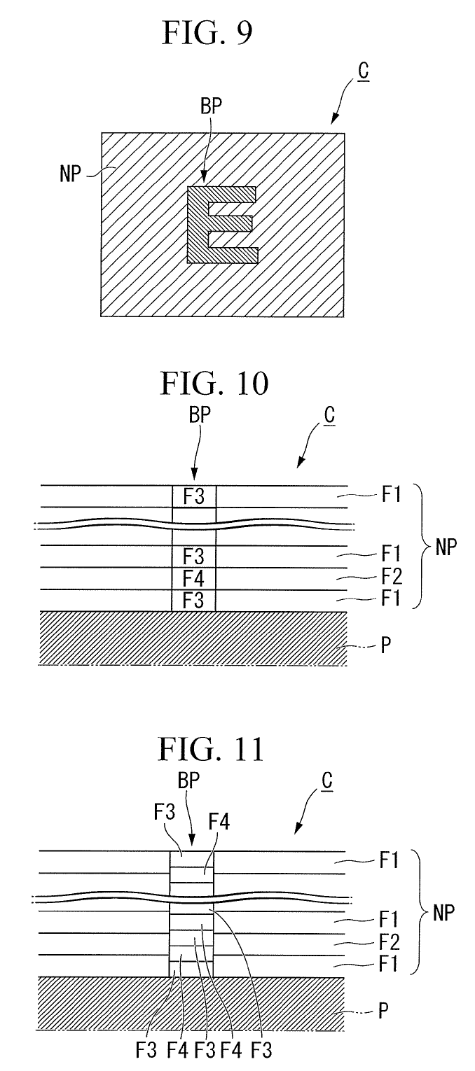

A third embodiment of a color developing structure C formed on a substrate P will be described with reference to FIGS. 9 to 11.

In the FIGS. 9 to 11, the same reference signs are given to the same elements as the constituent elements of the first embodiment shown in FIGS. 5 and 6, and the descriptions thereof are omitted.

In the first embodiment, the transparent thin film is not formed for the second pattern portion BP. However, in the third embodiment, a film is formed even for the second pattern portion BP.

As shown in FIGS. 9 and 10, for the first pattern portion NP similarly with the first embodiment, the first transparent thin film F1 and the second transparent thin film F2 are alternately stacked in layers. That is, in FIGS. 9 and 10, a first film body is formed on the first pattern portion NP, a second film body is formed on the second pattern portion BP, and the color developing structure C is thereby constituted by the first film body and the second film body.

For the second pattern portion BP, as shown in FIG. 10, a third transparent thin film F3 having a third refractive index formed using a third liquid material (third formation material) selected from the materials for forming a transparent thin film exemplified above, and a fourth transparent thin film F4 having a fourth refractive index similarly formed using a fourth liquid material (fourth formation material) are alternately stacked in layers. Therefore, the second film body is formed by the multi layers of the third transparent thin films F3 and the fourth transparent thin films F4.

In FIG. 10, with regard to the thickness of the third transparent thin film F3 and the fourth transparent thin film F4, the same thickness as the first transparent thin film F1 and the second transparent thin film F2 is exemplary.

The third liquid material and the fourth liquid material are selected, so that the second film body formed by laminating the third transparent thin film F3 and the fourth transparent thin film F4 has color developing characteristics (second color developing characteristics) different from the color developing characteristics (first color developing characteristics) of the first film body formed by laminating the first transparent thin film F1 and the second transparent thin film F2.

In the color developing structure C having the aforementioned configuration, for the first pattern portion NP, as described above, a color (first color developing characteristics) is developed according to the materials and the thicknesses of the first thin film F1 and the second transparent thin film F2. For the second pattern portion BP, a color (second color developing characteristics) is developed according to the materials and the thicknesses of the third transparent thin film F3 and the fourth transparent thin film F4. Accordingly, it is possible to easily and clearly form a character “E” formed in the second pattern portion BP by contrasting the difference in the color developing characteristics of the first pattern portion NP and the second pattern portion BP.

In the third embodiment, each of the thicknesses of the third transparent thin film F3 and the fourth transparent thin film F4 is described substantially equal to each of the thicknesses of the first transparent thin film F1 and the second transparent thin film F2. However, actually, each of the thicknesses of the third transparent thin film F3 and the fourth transparent thin film F4 is determined depending on the color developed in the second pattern portion BP.

Accordingly, as shown in FIG. 10, each of the thicknesses of the third transparent thin film F3 and the fourth transparent thin film F4 may be substantially equal to each of the thicknesses of the first transparent thin film F1 and the second transparent thin film F2. As shown in FIG. 11, the transparent thin films of the second pattern portion BP may be stacked in layers so that each of the thicknesses of the third transparent thin film F3 and the fourth transparent thin film F4 is different from that of the first pattern portion NP depending on a desired color (color developing characteristics).

### Fourth Embodiment

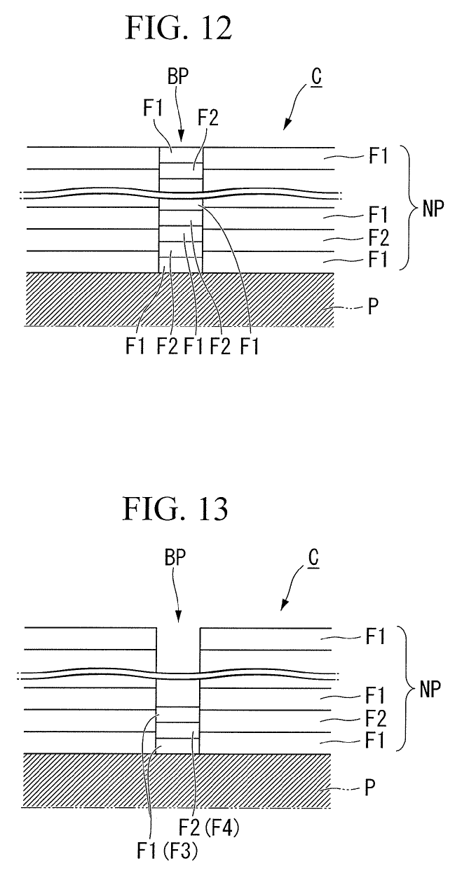

A fourth embodiment of a color developing structure C formed on a substrate P will be described with reference to FIG. 12.

In the FIG. 12, the same reference signs are given to the same elements as the constituent elements of the third embodiment shown in FIG. 11, and the descriptions thereof are omitted.

As shown in FIG. 12, in the fourth embodiment, the second film body is formed by laminating the first transparent thin film F1 and the second transparent thin film F2 even in the second pattern portion BP.

That is, the aforementioned first liquid material is used as the third liquid material in the third embodiment, and the aforementioned second liquid material is used as the fourth liquid material.

The thicknesses of the transparent thin films F1 and F2 are different from that of the first pattern portion NP, so that color developing characteristics of the second film body in the second pattern portion BP is different from color developing characteristics in the first pattern portion NP. For example, the first transparent thin film F1 is formed with a thickness of 84.5 nm, and the second transparent thin film F2 is formed with a thickness of 47.6 nm, to produce a blue color in the second film body.

In the color developing structure C having the aforementioned configuration, for the first pattern portion NP, as described above, a color is developed according to the materials and the thicknesses of the first transparent thin film F1 and the second transparent thin film F2. For the second pattern portion BP, a color is developed with color developing characteristics different from that of the first pattern portion NP, according to the thicknesses of the first transparent thin film F1 and the second transparent thin film F2. Accordingly, it is possible to easily and clearly form a character “E” formed in the second pattern portion BP by contrasting the difference in the color developing characteristics of the first pattern portion NP and the second pattern portion BP.

In the embodiment, since the second pattern portion BP and the first pattern portion NP can be formed using the same material, it is possible to reduce the number of kinds of prepared materials, thereby improving productivity.

### Fifth Embodiment

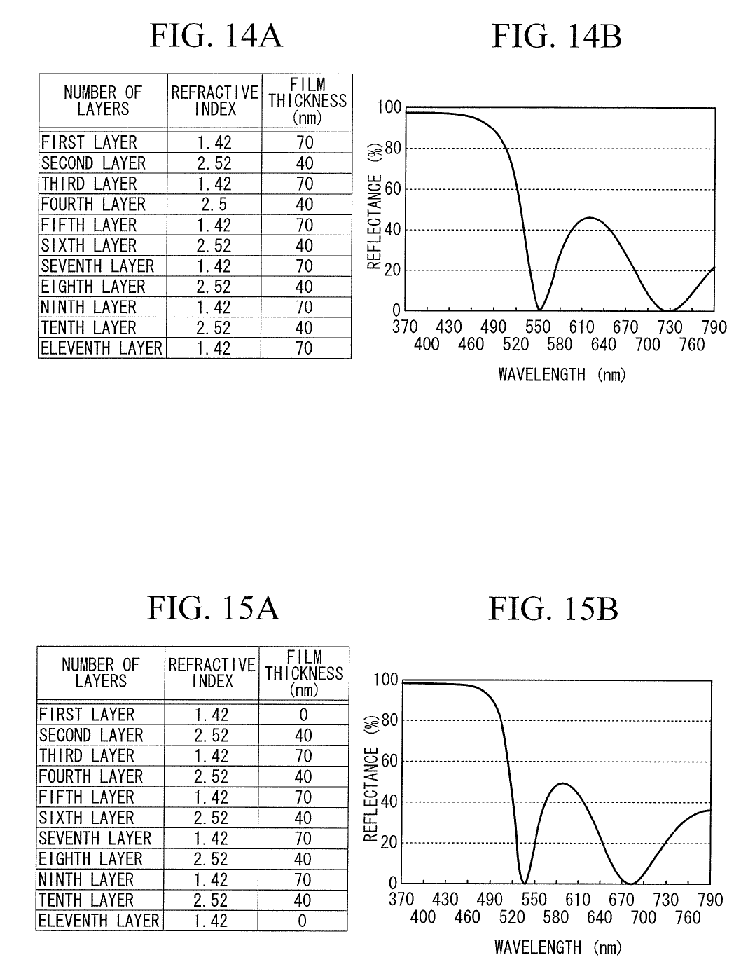

A fifth embodiment of a color developing structure C formed on a substrate P will be described with reference to FIG. 13.

In the FIG. 13, the same reference signs are given to the same elements as the constituent element of the third embodiment and the fourth embodiment shown in FIGS. 11 and 12, and the description thereof is omitted.

As shown in FIG. 13, in the fifth embodiment, the number of layers in the second pattern portion BP is reduced so that the thickness of the second film body in the second pattern portion BP is less than the thickness of the first film body in the first pattern portion NP.

In this case, as a transparent thin film in the second pattern portion BP, the first transparent thin film F 1 and the second transparent thin film F2 may be formed using the first liquid material and the second liquid material, or the third transparent thin film F3 and the fourth transparent thin film F4 may be formed using the third liquid material and the fourth liquid material.

In the color developing structure C having this configuration, it is possible to make a character “E” visible on the basis of the difference in the color developing characteristics of the second pattern portion BP and the first pattern portion NP, and it is possible to easily and clearly form the pattern formed in the second pattern portion BP by a reflection intensity (brightness) caused by the difference in thickness.

When the first transparent thin film F1 and the second transparent thin film F2 are laminated in the second pattern portion BP so that the thickness (total thickness) thereof is less than that of the first pattern portion NP. For example, as described in the third embodiment with reference to FIG. 10, the thicknesses of the first transparent thin film F1 and the second transparent thin film F2 are preferably formed substantially equal to the first pattern portion NP.

Accordingly, the transparent thin films in the second pattern portion BP and the first pattern portion NP can be entirely formed in the same process, and thus it is possible to further improve productivity.

### Sixth Embodiment

A sixth embodiment of a color developing structure C and a method for manufacturing the same will be described with reference to FIGS. 14A to 21B.

In the first to fifth embodiments, the first transparent thin film F1, the second transparent thin film F2, or the third transparent thin film F3 and the fourth transparent thin film F4 are formed with the same thickness. However, in the sixth embodiment, in the above-described film body including the uppermost layer, the lowermost layer, and a plurality of intermediate layers, each of the thicknesses of the uppermost layer and the lowermost layer is different from the thickness of the one layer constituted of the intermediate layers.

The first transparent thin film F1, the second transparent thin film F2, the third transparent thin film F3, and the fourth transparent thin film F4 exhibit the same effect. Accordingly, the first transparent thin film F1 and the second transparent thin film F2 will mainly be described.

As described above, FIG. 14A shows the first transparent thin film F1 formed by the siloxane polymer (refractive index 1.42) in the odd layers and the second transparent thin film F2 formed by the titanium oxide (refractive index 2.52) in the even layers. In this case, in order to obtain a blue reflective spectrum of a wavelength of 430 to 450 nm, the thickness of the first transparent thin film F1 is 70 nm, and the thickness of the second transparent thin film F2 is 40 nm.

FIG. 14B is a diagram illustrating light emitting characteristics, specifically illustrating the relationship between a light emitting wavelength and a reflectance in the color developing structure C that is formed of the first transparent thin films F1 and the second transparent thin films F2 and has the eleven layers shown in FIG. 14A.

FIGS. 15A to 21A are diagrams illustrating that the thicknesses of the first layer that is the lowermost layer and the eleventh layer that is the uppermost layer are changed 0 times (i.e., thickness is zero), 0.5 times, 1.5 times, 2 times, 3 times, four times, and five times the thickness of the transparent thin film that has a great thickness (70 nm) in the first transparent thin films F1 and the second transparent thin films F2 that constitute one of the intermediate layers (second to tenth layers) shown in FIG. 14A.

FIGS. 14B to 21B are diagrams illustrating light emitting characteristics, specifically illustrating the relationship between a light emitting wavelength and a reflectance in the color developing structure C that is formed of the first transparent thin films F1 and the second transparent thin films F2 and has the eleven layers shown in FIGS. 14A to 21A.

As shown in the light emitting characteristics of FIGS. 14B, 15B, and 16B, when the thicknesses of the uppermost layer and the lowermost layer are less than the thickness of the layer that constitutes one of the intermediate layers and has a great thickness in the intermediate layers, a reflective peak becomes large in a wavelength region except for a predetermined region.

As shown in the light emitting characteristics of FIGS. 17B, 18B, and 21B, when the thicknesses of the uppermost layer and the lowermost layer are 1.5 times, 2 times, and 5 times the thickness of the layer that constitutes one of the intermediate layers and has a great thickness in the intermediate layers, it is possible to decrease a reflective peak in a wavelength region except for a predetermined region.

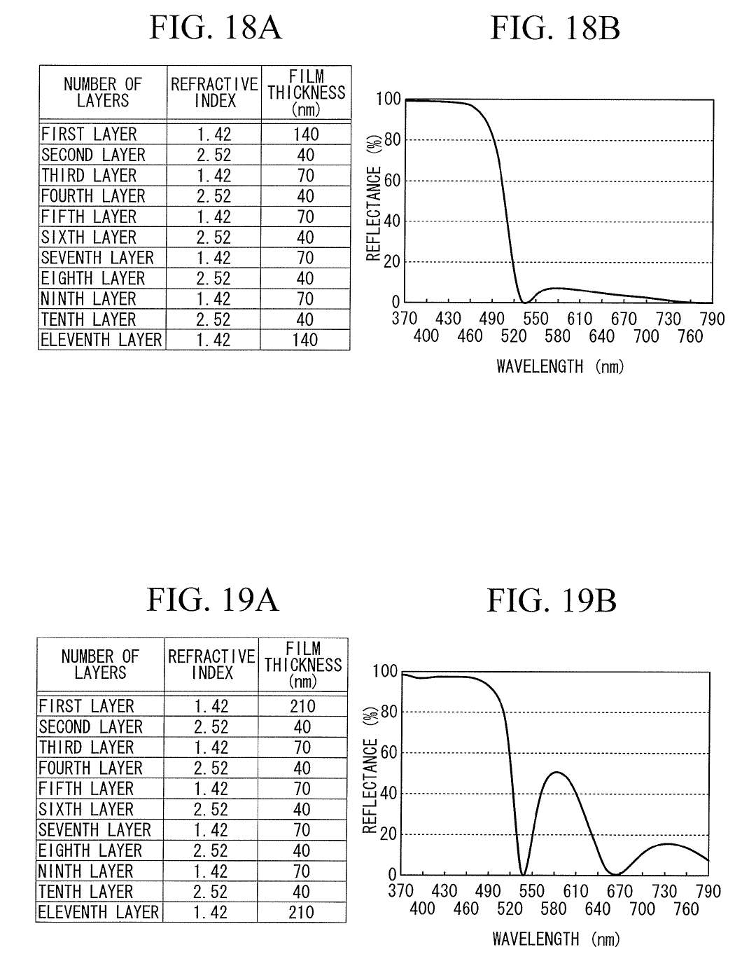

As shown in the light emitting characteristics of FIGS. 18B, 19B, and 20B, when the thicknesses of the uppermost layer and the lowermost layer are 2 times, 3 times, and 4 times the thickness of the layer that constitutes one of the intermediate layers and has a great thickness in the intermediate layers, it is possible to decrease a wavelength region of a reflective peak occurring in a region except for a predetermined region.

Accordingly, in the embodiment, in addition to the same effect as the first embodiment, it is possible to obtain more satisfactory color developing characteristics by the uppermost layer and the lowermost layer having thicknesses greater than that of the layer that constitutes one of the intermediate layers and has a great thickness in the intermediate layers.

Particularly, in the embodiment, the thicknesses of the uppermost layer and the lowermost layer are formed 2 times (twice) the thickness of the layer that constitutes one of the intermediate layers and has a great thickness in the intermediate layers. Accordingly, it is possible to decrease the reflective peak in the wavelength region except for a predetermined region, and it is possible to decrease the wavelength region of the reflective peak occurring in the region except for the predetermined region, thereby obtaining a more satisfactory color developing characteristics.

### Seventh Embodiment

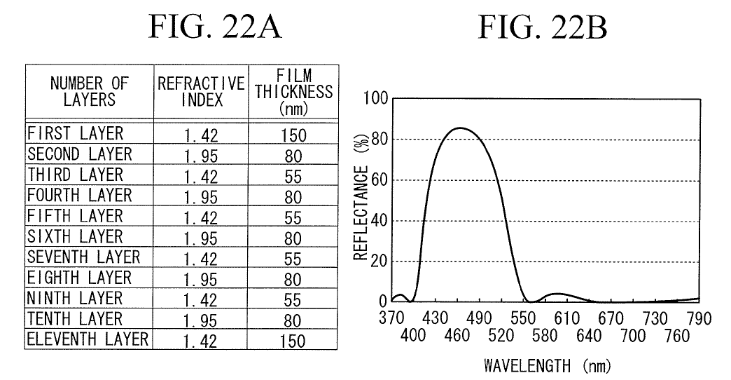

A seventh embodiment of a color developing structure C and a method for manufacturing the same will be described with reference to FIGS. 22A and 22B.

In the first to sixth embodiments, with respect to the first transparent thin film F1 and the second transparent thin film F2 (the third transparent thin film F3 and the fourth transparent thin film F4), the thickness of the first transparent thin film F1 having a small refractive index is greater than the thickness of the second transparent thin film F2 having a large refractive index. However, the seventh embodiment has a configuration opposite to that.

FIG. 22A shows a diagram illustrating thicknesses of the first transparent thin film F1 formed by a siloxane polymer (refractive index 1.42) in the odd layers and the second transparent thin film F2 formed by a zinc oxide (refractive index 1.95) in the even layers as described above. FIG. 22B is a diagram illustrating light emitting characteristics, specifically illustrating the relationship between a light emitting wavelength and a reflectance in the color developing structure C having the eleven layers shown in FIG. 22A.

As shown in FIG. 22A, in the embodiment, except for the thicknesses of the uppermost layer and the lowermost layer, the thickness of the first transparent thin film F1 having a small refractive index is less than the thickness of the second transparent thin film F2 having a large refractive index.

Similarly with the second embodiment, the thicknesses of the uppermost layer and the lowermost layer are greater than the thickness of the layer that constitutes one of the intermediate layers and has a great thickness in the intermediate layers.

As shown in FIG. 22B, also in the embodiment, it is possible to decrease the reflective peak in the wavelength region except for a predetermined region, and it is possible to decrease the wavelength region of the reflective peak occurring in the region except for a predetermined region, thereby obtaining a more satisfactory color developing characteristics.

As the color developing structure C described in the first to seventh embodiments, the invention can be widely applied to, for example, decorative members such as a clock character sheet, a bracelet, a brooch, and a mobile phone case (decorative member, exterior member). In addition, it is possible to efficiently (easily) form a decorative member (decorative member, exterior member) by using the color developing structure and the method for manufacturing the same. Accordingly, it is possible to obtain a decorative member (decorative member, exterior member) excellent in productivity with reduced cost.

The embodiments according to the invention have been described with reference to the accompanying drawings, but the invention is not limited to the related examples.

In the above-described examples, all shapes and combinations of the constituent elements are just examples, and may be variously modified within the scope of the concept of the invention on the basis of the design requirements or the like.

For example, in the embodiment, the first transparent thin film F1 (third transparent thin film F3) is formed in the odd layer and the second transparent thin film F2 (fourth transparent thin film F4) is formed in the even layer, but the invention is not limited thereto and it may be opposite thereto.

The number of transparent thin films described in the embodiment is an example. If desired refractive characteristics can be obtained, the number may be greater than or less than eleven layers, that is, the number may be any number.

As the thickness of the transparent thin film in the embodiment, at least one of the first transparent thin film F1 and the second transparent thin film F2 may be formed to have a thickness as big as the particle diameter of the material for forming the first transparent thin film or the material for forming the second transparent thin film.

In this case, in order not to pile particles included in the applied liquid material upon the layer, it is preferable to employ a method in which the liquid material contains a dispersion catalyst.

When the transparent thin film having a thickness greater than the particle diameter is formed, it is possible to precisely form a film having a regular thickness with uniformity by making the thickness of the transparent thin film be integer times the particle diameter and by repeating the process for forming the film having the thickness as big as the particle diameter.

In the embodiment, the configuration of a character such as “E” and the method for forming the character in a predetermined pattern are exemplified, but the invention is not limited thereto. For example, the invention can be applied to form various patterns such as numbers, shapes, pictures, and the like.

While preferred embodiments of the invention have been described and illustrated above, these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A method for manufacturing a color developing structure, comprising:
defining a first region and a second region adjacent to the first region on a base body;
forming, onto the first region, a first transparent thin film having a first refractive index by a liquid droplet ejection method with a first liquid material so that the first transparent thin film has a thickness determined based on first color developing characteristics;
forming, onto the first transparent thin film, a second transparent thin film having a second refractive index by a liquid droplet ejection method with a second liquid material so that the second transparent thin film has a thickness determined based on the first color developing characteristics; and
stacking the first transparent thin films and the second transparent thin films in layers by alternately repeating the forming of the first transparent thin film and the forming of the second transparent thin film multiple times so that a first film body having the first color developing characteristics is formed onto the first region and the color developing structure is thereby obtained.

2. The method according to claim 1, further comprising:
forming, onto the second region, a second film body having second color developing characteristics that is different from the first color developing characteristics so that the color developing structure is obtained.

3. The method according to claim 2, wherein
the forming of the second film body onto the second region, includes:
forming, onto the second region, a third transparent thin film having a third refractive index by a liquid droplet ejection method with a third liquid material so that the third transparent thin film has a thickness determined based on the second color developing characteristics;
forming, onto the third transparent thin film, a fourth transparent thin film having a fourth refractive index by a liquid droplet ejection method with a fourth liquid material so that the fourth transparent thin film has a thickness determined based on the second color developing characteristics; and
stacking the third transparent thin films and the fourth transparent thin films in layers by alternately repeating the forming of the third transparent thin film and the forming of the fourth transparent thin film multiple times.

4. The method according to claim 3, wherein
one of the first liquid material and the second liquid material is the same as the third liquid material, and the other of the first liquid material and the second liquid material is the same as the fourth liquid material.

5. The method according to claim 3, wherein
the third refractive index is less than the fourth refractive index, and the third transparent thin film is formed so that the thickness of the third transparent thin film is greater than the thickness of the fourth transparent thin film.

6. The method according to claim 3, wherein
each of the forming of the third transparent thin film and the forming of the fourth transparent thin film includes:
applying a liquid material; and
baking or drying the liquid material that has been applied.

7. The method according to claim 1, wherein
each of the forming of the first transparent thin film and the forming of the second transparent thin film includes:
applying a liquid material; and
baking or drying the liquid material that has been applied.

8. The method according to claim 1, wherein
the first refractive index is less than the second refractive index, and the first transparent thin film is formed so that the thickness of the first transparent thin film is greater than the thickness of the second transparent thin film.

9. The method according to claim 1, wherein
the first film body that is constituted by a plurality of the first transparent thin films and a plurality of the second transparent thin films includes a lowermost layer, an uppermost layer, and a plurality of intermediate layers, and wherein
the first transparent thin films and the second transparent thin films are formed so that the thicknesses of transparent thin films that are positioned at the lowermost layer and the uppermost layer are greater than the thickness of a transparent thin film that is positioned at one of the intermediate layers.

10. The method according to claim 9, wherein
the first transparent thin films and the second transparent thin films are formed so that the thicknesses of the transparent thin films that are positioned at the lowermost layer and the uppermost layer are twice the thickness of the transparent thin film that is positioned at one of the intermediate layers.

11. The method according to claim 1, wherein
the forming of the first transparent thin film and the second transparent thin film includes at least one of the forming the first transparent thin film that has the thickness determined based on a particle diameter of a first formation material used for forming the first transparent thin film, and the forming the second transparent thin film that has the thickness determined based on a particle diameter of a second formation material used for forming the second transparent thin film.

12. A color developing structure comprising:
a first transparent thin film that is formed with a first formation material, has a thickness determined based on first color developing characteristics, and has a first refractive index;
a second transparent thin film that is formed on the first transparent thin film with a second formation material, has a thickness determined based on the first color developing characteristics, and has a second refractive index; and
a first film body in which the first transparent thin films and the second transparent thin films are alternately stacked in layers.

13. The color developing structure according to claim 12, further comprising:
a second film body, that is formed on a region different from the region on which the first film body is formed, has second color developing characteristics different from the first color developing characteristics.

14. The color developing structure according to claim 13, wherein
the second film body includes:
a third transparent thin film that is formed with a third formation material, has a thickness determined based on the second color developing characteristics, and has a third refractive index; and
a fourth transparent thin film that is formed with a fourth formation material, has a thickness determined based on the second color developing characteristics, and has a fourth refractive index, wherein
the second film body is formed by alternately stacking the third transparent thin films and the fourth transparent thin films in layers.

15. The color developing structure according to claim 14, wherein
one of the first formation material and the second formation material is the same as the third formation material, and the other of the first formation material and the second formation material is the same as the fourth formation material.

16. The color developing structure according to claim 14, wherein
the third refractive index is less than the fourth refractive index, and the third transparent thin film is formed so that the thickness of the third transparent thin film is greater than the thickness of the fourth transparent thin film.

17. The color developing structure according to claim 12, wherein
the first refractive index is less than the second refractive index, and the first transparent thin film is formed so that the thickness of the first transparent thin film is greater than the thickness of the second transparent thin film.

18. The color developing structure according to claim 12, wherein
the first film body that is constituted by a plurality of the first transparent thin films and a plurality of the second transparent thin films includes a lowermost layer, an uppermost layer, and a plurality of intermediate layers, and wherein
the first transparent thin films and the second transparent thin films are formed so that the thicknesses of transparent thin films that are positioned at the lowermost layer and the uppermost layer are greater than the thickness of a transparent thin film that is positioned at one of the intermediate layers.

19. The color developing structure according to claim 18, wherein
the first transparent thin films and the second transparent thin films are formed so that the thicknesses of the transparent thin films that are positioned at the lowermost layer and the uppermost layer are twice the thickness of the transparent thin film that is positioned at one of the intermediate layers.

20. The color developing structure according to claim 12, wherein
the thickness of the first transparent thin film is defined based on a particle diameter of the first formation material.

21. The color developing structure according to claim 12, wherein
the thickness of the second transparent thin film is defined based on a particle diameter of the second formation material.
